(19) United States
(12) Patent Application Publication
(10) Pub. No.: US 2016/0085958 A1
(43) Pub. Date: Mar. 24, 2016

(54) METHODS AND APPARATUS FOR MULTI-FACTOR USER AUTHENTICATION WITH TWO DIMENSIONAL CAMERAS

(71) Applicant: Intel Corporation, Santa Clara, CA (US)

(72) Inventor: Xiaozhu Kang, Fremont, CA (US)

(21) Appl. No.: 14/492,163

(22) Filed: Sep. 22, 2014

(51) Int. Cl. G06F 21/40; G06F 21/36; G06F 3/01; G06K 9/00

(52) U.S. Cl. CPC G06F 21/40; G06K 9/00389; G06K 9/00087; G06K 9/00067; G06K 9/00288; G06F 21/36; G06F 3/017

(57) ABSTRACT

A data processing system (DPS) includes a user authentication module that uses a hand recognition module and a gesture recognition module to authenticate users, based on video data from a two-dimensional (2D) camera. When executed, the hand recognition module performs operations comprising (a) obtaining 2D video data of a hand of the current user; and (b) automatically determining whether the hand of the current user matches the hand of an authorized user, based on the 2D video data. When executed, the gesture recognition module performs operations comprising (a) presenting a gesture challenge to the current user, wherein the gesture challenge asks the current user to perform a predetermined hand gesture; (b) obtaining 2D video response data; and (c) automatically determining whether the current user has performed the predetermined hand gesture, based on the 2D video response data. Other embodiments are described and claimed.

### TECHNICAL FIELD

Embodiments described herein relate generally to data processing and in particular to methods and apparatus for authenticating users.

### BACKGROUND

In the field of computer science, user authentication refers to the process of determining whether a user of a data processing device actually is who the user claims to be. For instance, the owner of a laptop computer, a smartphone, or practically any other type data processing device may configure a security system in the device with a password that must be entered to unlock the device. Whenever a user subsequently tries to unlock the device, the device may prompt the user for the password, to make sure the current user is actually the owner. Typically, if the current user is not the owner, the current user will not know the password. Consequently, the current user will typically fail the user authentication process.

For enhanced security, a device may use multiple factors for authentication. For instance, a device may require the user to enter a password and also to pass a fingerprint scan. However, conventional approaches to user authentication entail various disadvantages.

The present disclosure describes methods and apparatus which utilize multi-factor authentication and two-dimensional (2D) cameras to authenticate users.

### BRIEF DESCRIPTION OF THE DRAWINGS

FIG. 1 is a block diagram of an example data processing system with features for utilizing multiple factors and a 2D camera for user authentication.

FIG. 2 is a flowchart of an example process for preparing the local data processing system of FIG. 1 to utilize multiple factors and a 2D camera for user authentication.

FIGS. 3A and 3B present a flowchart of an example process for utilizing multiple factors and a 2D camera for user authentication.

FIG. 4 is a schematic diagram representing an example hand geometry feature vector.

FIG. 5 is a schematic diagram representing another example hand geometry feature vector.

### DESCRIPTION OF EMBODIMENTS

As indicated above, the present disclosure describes methods and apparatus which utilize multi-factor authentication and 2D cameras to authenticate users. As described in greater detail below, in one example embodiment, a data processing system includes a user authentication module and a 2D camera, and the user authentication module uses the camera to perform hand recognition and gesture recognition.

The user authentication module may utilize the hand recognition aspects as an inherence factor (in other words, something only the user is). In addition, the user authentication module may utilize the gesture recognition aspects as a knowledge factor (in other words, something only the user knows). Furthermore, the user authentication module may use the gesture recognition aspects as a liveness test or Turing test, to determine whether the entity or “user” providing the authentication evidence to the data processing system is a person who is present at the data processing system.

Moreover, the user authentication module may execute within a secure or sequestered environment within the data processing system, and the user authentication module may save authentication templates and/or other authentication data in secure storage.

For purposes of illustration, the present disclosure describes one or more example embodiments. However, the present teachings are not limited to those particular embodiments.

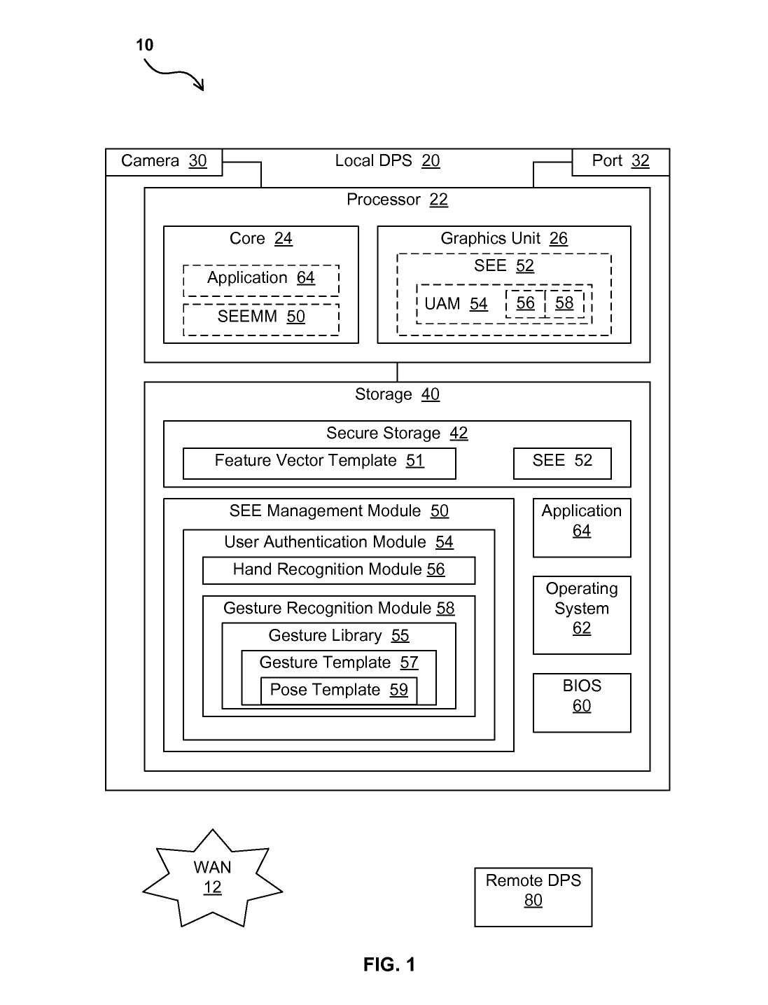

FIG. 1 is a block diagram of an example data processing system 10 with features for utilizing multiple factors and a 2D camera for user authentication, according to one embodiment. In the embodiment of FIG. 1, data processing system 10 is a distributed data processing system including a local data processing system (DPS) 20 and a remote DPS 80. In the embodiment of FIG. 1, local DPS 20 and remote DPS 80 may communicate with each other via a local area network (LAN) and/or a wide area network (WAN) 12, such as the Internet.

In the embodiment of FIG. 1, local DPS 10 includes at least one processor 22 in communication with storage 40, a 2D camera 30, and one or more ports 32. Processor 22 includes multiple execution units, including one or more processor cores 24 and one or more graphics units 26. Port 32 may be used for network communications, for input, for output, and/or for both input and output. Storage 40 may be implemented using any suitable storage technology or combination of storage technologies, including without limitation cache memory, random access memory (RAM), read-only memory (ROM), a hard disk drive (HDD), a solid state drive (SSD), and/or other types of volatile and/or non-volatile storage technologies. Remote DPS 80 may include components like those in source DPS 20 and/or any other suitable components.

In the embodiment of FIG. 1, storage 40 includes a basic input/output system (BIOS) 60, an operating system 62, and one or more applications 64. Storage 40 also includes one or more areas of secure storage 42. For purposes of this disclosure, secure storage 42 is storage that is protected from unauthorized access. In other words, secure storage 42 is inaccessible to non-authorized entities, whether those entities are executing on processor core 24 or on graphics unit 26.

In the embodiment of FIG. 1, at least part of secure storage 42 is protected at the platform level. In other words, the protection is provided by components which execute below the level of the operating system and below the level of user applications, so that faulty or malicious code in the operating system or in a user application is unable to access the data in secure storage 42.

As described in greater detail below, in the embodiment of FIG. 1, secure storage 42 includes a secure execution environment (SEE) 52. Also, storage 40 includes an SEE management module (SEEMM) 50. Local DPS 20 may use SEEMM 50 to create and manage SEE 52. In addition or alternatively, other modules may create and manage some or all of secure storage 42. Also, some or all of secure storage 42 may reside in volatile memory such as RAM and/or cache memory. In addition or alternatively, some or all of secure storage 42 may reside on one or more nonvolatile storage devices (e.g., on an SSD, on a HDD, etc.). For example, SEE 52 may reside in RAM and in cache memory, and a feature vector template 51 which describes one of the hands of the owner of local DPS 20 may reside on an HDD. In addition or alternatively, a portion of SEE 52 may reside on an HDD. Also, local DPS 20 may include feature vector templates for multiple users, and one or more of those templates (e.g., the template for the current user) may reside in RAM and/or in cache memory.

In the embodiment of FIG. 1, SEEMM 50 includes a user authentication module 54, and user authentication module 54 includes a hand recognition module 56 and a gesture recognition module 58. Gesture recognition module 58 includes a gesture library 55 describing various predetermined gestures. Each gesture in gesture library 55 may be characterized by a predetermined gesture pattern or template 57, and each gesture template 57 may include a predetermined pose template 59 or a predetermined sequence of pose templates. Each pose template 59 may use a set of hand feature descriptors to represent a particular pose.

Local DPS 20 may copy code for software components from one or more nonvolatile storage devices into RAM before executing those instructions. In addition, SEEMM 50 and/or other modules may configure local DPS 20 to execute some software components on core 24 and other components on GU 26. For instance, FIG. 1 depicts SEEMM 50 with dashed lines within core 24 to illustrate that SEEMM 50 may execute on core 24. Similarly, FIG. 1 depicts SEE 52 and user authentication module 54 with dashed lines within graphics unit (GU) 26 to illustrate that SEEMM 50 may configure local DPS 20 to execute user authentication module 54 within SEE 52 on GU 26.

User authentication module 54 may be used by BIOS 60, by operating system 62, and/or by application 64 to authenticate users. For instance, BIOS 60 or operating system 62 may call user authentication module 54 for user authentication whenever a user is starting, restarting, or unlocking local DPS 20. In addition or alternatively, application 64 may call user authentication module 54 for user authentication whenever a user launches application 64.

In addition or alternatively, application 64 may be a web browser, and whenever a user attempts to access another application, service, or other resource on remote DPS 80, remote DPS 80 may cause application 64 to utilize user authentication module 54 for user authentication. Thus, user authentication module 54 may be used as log in interface on a log in screen for the user to log in to his or her machine, as a log in page in a web browser, etc.

In one embodiment, SEEMM 50 uses the technology distributed by Intel Corporation under the name or trademark Trusted Execution Technology (TXT) to measure user authentication module 54, to validate that measurement, and after successful validation, to launch user authentication module 54 within SEE 52 on GU 26. More information about Intel® TXT is available at www.intel.com/content/dam/www/public/us/en/documents/white-papers/trusted-execution-technology-security-paper.pdf. Accordingly, BIOS 60, operating system 62, and/or application 64 may interact with user authentication module 54 via Intel® TXT.

In other embodiments, the SEEMM and/or other components of the data processing system may use different security systems or features to protect feature vector templates and to execute user authentication modules within secure or sequestered environments for template matching, for presenting output and receiving input, etc. For instance, a data processing system may use technologies such as those described in U.S. patent application publication no. 20140096068, entitled “Device And Method For Secure User Interface Gesture Processing Using Processor Graphics.” For example, the processor may include security primitives which provide for the creation of hardware-enforced SEEs. Such SEEs may verify the authenticity of code before executing that code, and such SEEs may prevent access or modifications of the code by unauthorized entities (e.g., applications, operating systems, libraries, drivers, virtual machines, virtual machine monitors, processes, threads, etc.) running in the data processing system. In other words, no software is allowed to execute within an SEE unless that software has first been verified as safe, and software executing outside of a SEE is not able to access any of the storage areas protected by the SEE. SEEs may be implemented as secure enclaves, virtualized partitions, sandboxes, etc. The data processing system may also provide for secure communication between the user authentication module and input/output (I/O) devices, such as a camera, a display, etc. For instance, the user authentication module may encrypt data to be sent to a display device, and user authentication module may decrypt data received from the camera.

In addition or alternatively, a data processing system may use technologies such as those described in U.S. patent application publication no. 20140157410, entitled “Secure Environment For Graphics Processing Units.” For example, a data processing system may construct a secure enclave using a set of privileged instructions, and the data processing system may execute a user authentication module within that secure enclave. The secure enclave may include a physically protected area of memory called the enclave page cache. The user authentication module may execute within that enclave page cache. The data processing system may ensure that memory pages belonging to the enclave page cache can only be accessed by the enclave that owns those pages.

In addition or alternatively, a data processing system may use technologies such as those described in U.S. patent application publication no. 20140230046, entitled “Turing Test Based User Authentication And User Presence Verification System, Device, And Method.” For example, when presenting the user with a challenge (e.g., instructions for a hand gesture to be performed by the user), a user authentication module may use a secure video output path, a protected media path, a protected audio/video path (PAVP), etc.

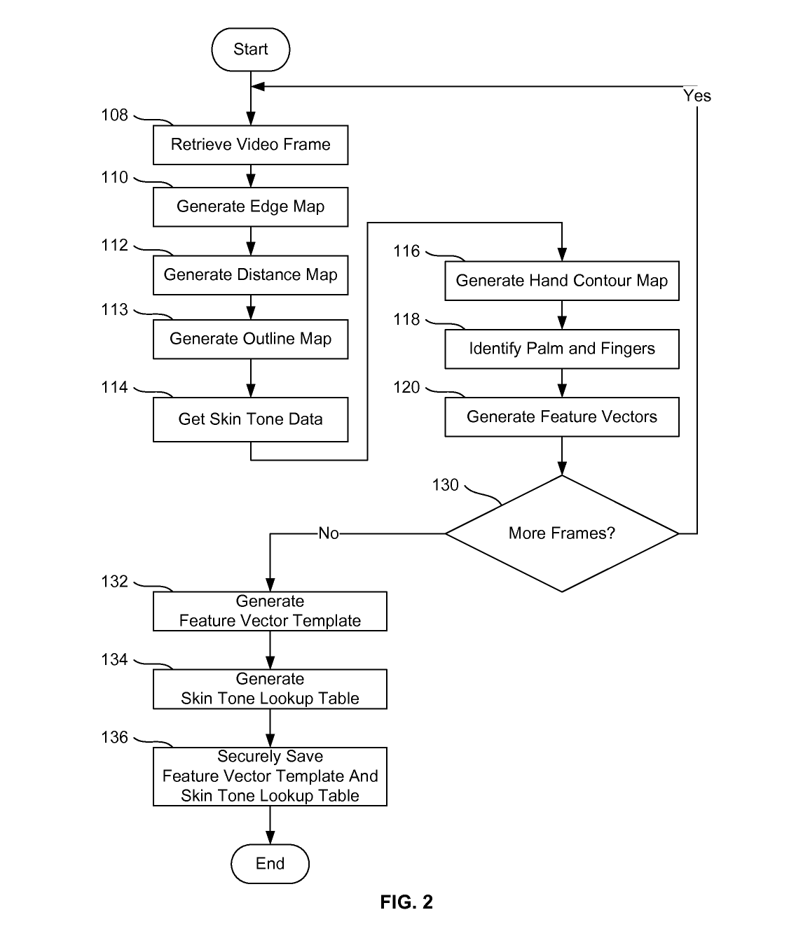

FIG. 2 is a flowchart of an example process for preparing local DPS 20 to utilize multiple factors and a 2D camera for user authentication. In one embodiment, user authentication module 54 utilizes hand recognition module 56 to perform the operations of FIG. 2. In other embodiments, other modules may perform some or all the operations depicted in FIG. 2.

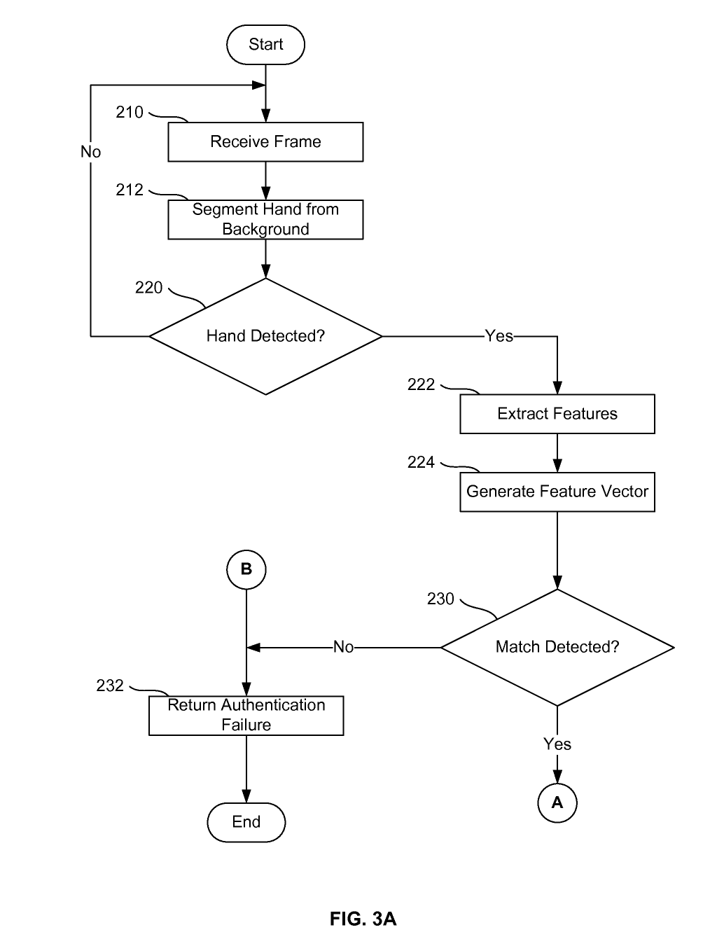

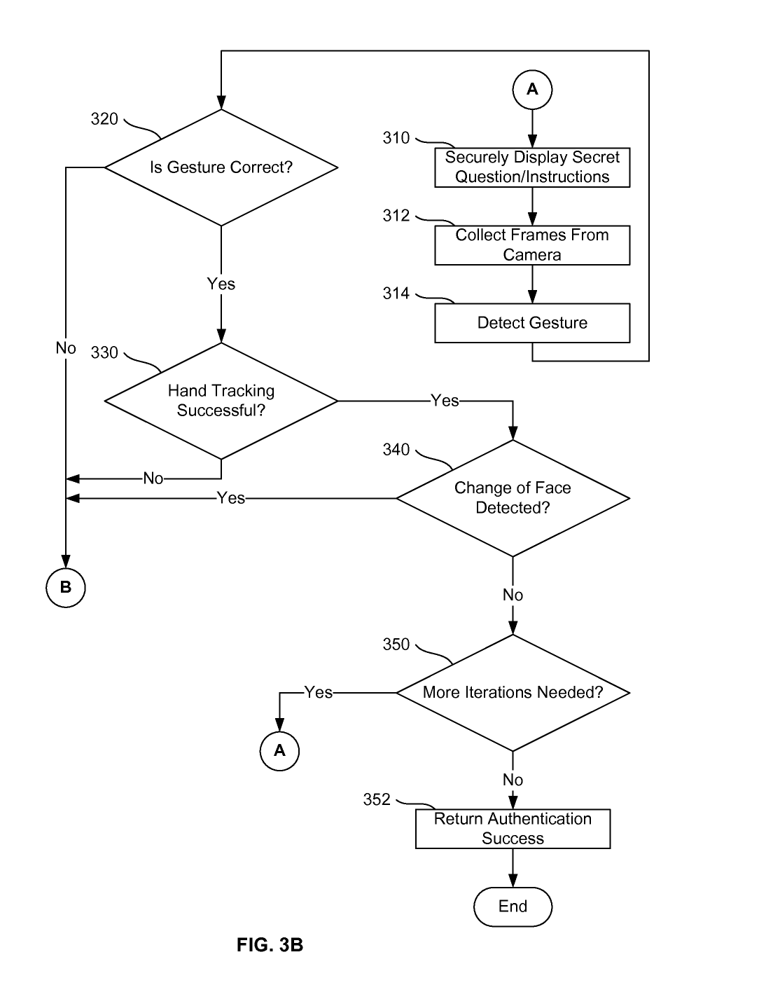

By executing the operations depicted in FIG. 2, hand recognition module 56 generates a feature vector template for a hand of an authorized user (e.g., feature vector template 51). Feature vector templates may also be referred to as hand recognition templates, hand geometry templates, hand biometric templates, or simply hand templates. The hand template generated according to FIG. 2 may be referred to as a known good template or as the original template. As described in greater detail below with regard to FIG. 3, hand recognition module 56 may subsequently use the original template to determine whether a current user is the authorized user.

The process of FIG. 2 may start after user authentication module 54 has collected numerous frames of 2D video to be used as training data. For instance, to perform initial configuration, for user authentication module 54 may use camera 30 to collect video frames with images of one of the hands of the owner of local DPS 20. Each frame may contain an image of the anterior or palmar surface of the hand. User authentication module 54 may be configured to collect a predetermined number of frames as training data for generating a feature vector template. Any suitable number of frames may be required. For instance, in some embodiments or circumstances, user authentication module 54 may collect hundreds of frames. In other embodiments or circumstances, user authentication module 54 may collect thousands of frames. The video frames may come from a live feed from camera 30, from a file containing moving video, or from files containing still images. For purposes of this disclosure, the frame or frames from which the original template will be derived may be referred to as the original frames or the original images. In the embodiment of FIG. 2, the hand in the original image is the hand of an authorized user (e.g., the owner of local DPS 20).

The process of FIG. 2 may begin at block 108, after those frames have been collected, with hand recognition module 56 retrieving the first of those frames from the collection. As shown at block 110, hand recognition module 56 may then perform edge detection on the frame to generate an edge map. The edge map may be a bitmap within which the bit value of 1 denotes pixels of significant edges. Those edges include the contour lines of the hand. As shown at block 112, hand recognition module 56 then uses the edge map to generate a distance map. Each element in the distance map denotes the shortest distance between its corresponding pixel and an edge pixel. As shown at block 113, hand recognition module 56 then uses the edge map and the distance map to generate an outline map that identifies the outline of the hand. For instance, hand recognition module 56 may use an iterative closest point matching algorithm to generate the outline map, based on the edge map and the distance map. The outline map may distinguish the pixels within the outline (i.e., the hand pixels) from the background pixels. However, until additional processing is done, hand recognition module 56 may be uncertain as to whether or not the image actually contains a hand. Nevertheless, hand recognition module 56 generates an outline map for an object that may ultimately be confirmed to be a hand. For ease of reference, that object is referred to herein as a hand, and the corresponding pixels are referred to as hand pixels.

As shown at block 114, hand recognition module 56 may then extract skin tone data for the hand from the image, based on the hand pixels identified by the outline map. As shown at block 116, hand recognition module 56 may then generate a hand contour map. The hand contour map includes numerous circles or other geometric shapes of various sizes, positioned within and substantially filling the outline of the hand.

As shown at block 118, hand recognition module 56 may then use the contour map to determine which parts of the image show which parts or features of the hand. In one embodiment, hand recognition module 56 first finds the fingertips, to identify the hand outline and/or orientation, and hand recognition module 56 then finds the palm. Thus, hand recognition module 56 may derive the hand geometry based one the position and angle of one or more fingers. Also, upon locating the palm and fingers, hand recognition module 56 may conclude that the image does actually contain a hand.

Hand recognition module 56 may then save hand geometry data describing the identified features. The hand geometry data may also be referred to as feature descriptors. For instance, the hand geometry data may include feature descriptors such as (a) palm descriptors that indicate which parts of the image show the palm, (b) finger descriptors that indicate which parts of the image show the fingers, and (c) border descriptors that identify the outer borders, edges, or outlines of the palm and of each finger. Accordingly, the process of locating the different parts of the hand within the image may also be referred to as feature descriptor generation. User authentication module 54 may subsequently use the feature descriptors for gesture recognition and for hand tracking, where hand tracking is the process of identifying the location of a hand in frames coming from a continuous video stream.

As shown at block 120, hand recognition module 56 may then generate a hand geometry feature vector, based on the hand contour map and/or the feature descriptors. For purposes of this disclosure, a feature vector is a collection of data elements or fields that represent various features of an object (such as a hand). Accordingly, hand recognition module 56 generates a hand geometry feature vector which describes or represents various aspects of the hand in the image. In one embodiment, a feature vector may include, without limitation, the size of the palm, the width and length of each finger, and the distance between each fingertip and the adjacent finger valley. A feature vector may contain a collection of feature descriptors.

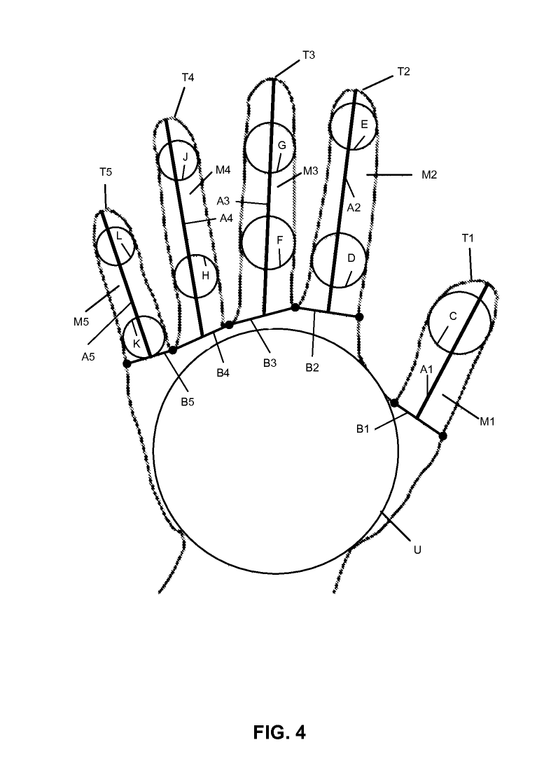

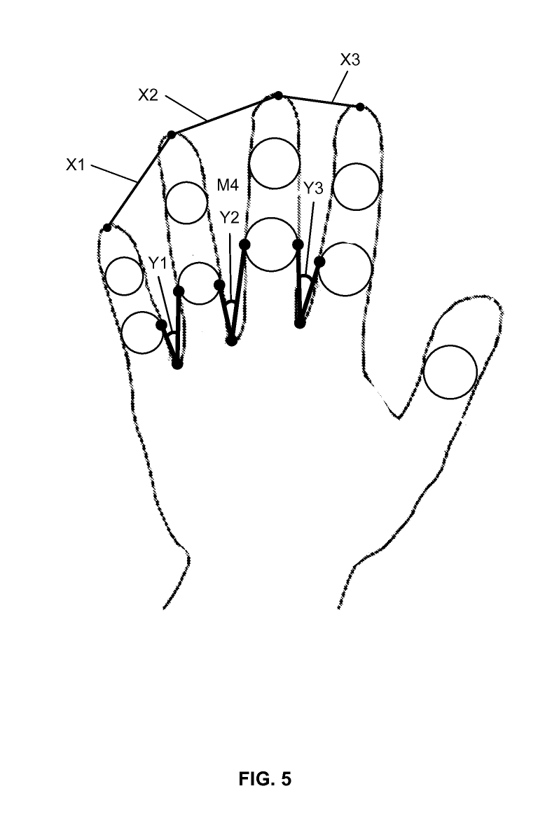

FIGS. 4 and 5 represent two different examples of hand geometry feature vectors. In FIG. 4, the following fields or feature descriptors characterize the following features:
A1-A5 describe the total length of respective fingers;
B1-B5 describe the bottom width of respective fingers;
C-H and J-L describe the width of respective finger knuckles;
M1-M5 describe the length from the first finger knuckle to the second finger knuckle of respective fingers;
T1-T5 describe the fingertip arc radius of respective fingers; and
W describes the size of the palm.
   In FIG. 5, the following fields characterize or describe the following features:
X1-X3 describe the slopes of the lines connecting four fingertips; and
Y1-Y3 describe the angles between four fingers.
   Different implementations or configurations may include any suitable combination of any of the above vectors or any other suitable vectors, including without limitation the length ratio between fingers. In one embodiment, at least one of the vectors is a substantially invariant feature that can be derived from hand images without much dependency on the hand's pose, rotation, and distance from the camera, and without much dependency on the background environment, while still being different enough from person to person to be suitable for authentication.

Referring again to FIG. 2, as shown at block 130, hand recognition module 56 may then determine whether there are more frames remaining to be analyzed. If hand recognition module 56 determines that more frames remain to be analyzed, the process may return to block 108, with additional frames being processed as described above.

However, once all of the frames have been processed, the process of FIG. 2 may pass from block 130 to block 132, with hand recognition module 56 using the hand geometry feature vector from each frame to generate feature vector template 51 for the authorized user. Feature vector template 51 may include fields to characterize each of the features reflected in the feature vectors, and hand recognition module 56 may populate each those fields with a value that is the mean or average of the corresponding values in the feature vectors.

Accordingly, like the hand geometry feature vectors, feature vector template 51 describes or represents the features of the authorized user's hand. Those features may include some or all of the features discussed above with regard to the feature vectors. The combination of values in feature vector template 51 may be unique for each person. In other words, the combination of values for one person may be different from the combination of values for every other person. Accordingly, feature vector template 51 may be considered a biometric template.

In addition, as shown at block 134, hand recognition module 56 may generate a skin tone lookup table for the authorized user. The skin tone lookup table may characterize the skin tone for the hand in the image. For instance, hand recognition module 56 may calculate a statistical distribution for the skin tone of the authorized user's hand, based on the skin tone data from the sample frames. The skin tone lookup table may contain or represent that distribution.

In one embodiment, hand recognition module 56 uses an expectation-maximization (EM) algorithm to compute or derive a collection of blobs that represent the hand, and hand recognition module 56 builds a Gaussian mixture model (GMM) for the skin tone distribution, based on the blobs. The training data for the blobs and the GMM may be the pixel color values in the skin tone data that was previously extracted from the frames by hand recognition module 56. The skin tone lookup table may contain or represent that GMM.

As shown at block 136, hand recognition module 56 may then save the generated template (e.g., feature vector template 51) and the skin tone lookup table in secure storage 42. The process of FIG. 3 may then end.

As described in greater detail below, when subsequently authenticating a user, hand recognition module 56 may use the feature vector template and the skin tone lookup table to perform pattern matching against a new image of a hand.

FIGS. 3A and 3B present a flowchart of an example process for utilizing multiple factors and a 2D camera for user authentication. In one embodiment, user authentication module 54 utilizes hand recognition module 56 and gesture recognition module 58 to perform some or all of the operations of FIGS. 3A and 3B. In other embodiments, one or more other modules may perform some of all of those operations. The process of FIGS. 3A and 3B may be referred to as an online process, and it may start after completion of the offline process described with regard to FIG. 3. For instance, the process of FIGS. 3A and 3B may start in response to the current user trying to access a protected resource (e.g., trying to unlock local DPS 20, trying to access a protected website, trying to access a protected application, etc.). In response, the protected resource may call user authentication module 54 to start the authentication process.

Consequently, that authentication process may start at block 210 with hand recognition module 56 receiving a live frame from camera 30. That frame may be referred to as the sample frame, the new frame, or the current frame. As shown at block 212, hand recognition module 56 may then perform hand segmentation. As part of the hand segmentation process, hand recognition module 56 may determine which parts of the current frame (if any) contain a hand, and which parts constitute the background.

To perform hand segmentation, hand recognition module 56 may use operations like those described above with regard to blocks 110, 112, 113, 114, 116, 118 and 120 of FIG. 2, for example. In addition or alternative, hand recognition module 56 may use the skin tone lookup table that was generated by the offline process as reference to find the skin tone area in the new frame. For example, hand recognition module 56 may pass the current frame through a pixel filtering stage, using the skin-tone distribution from the skin tone lookup table. The output is a modified current frame, where only skin-tone pixels remain in the frame. Non-skin pixels are replaced with color values set to zero. The result of the hand segmentation process may be a hand contour map and/or a feature descriptors for the current frame.

As shown at block 220, hand recognition module 56 may then determine whether the current frame contains a hand. If no hand was detected, the process may return to block 210, with hand recognition module 56 receiving a new frame and checking that frame for a hand, as indicated above.

However, if hand recognition module 56 was able to detect a hand in the frame, hand recognition module 56 may proceed to perform hand biometric verification. For purposes of this disclosure, the process of extracting hand data from a frame and checking that data against the feature vector template for an original hand may be referred to as hand biometric verification. As part of the process of hand biometric verification, user hand recognition module 56 may extract the features of the new hand, as shown at block 222, and may derive a hand geometry feature vector for the new hand based on the extracted features, as shown at block 224. To perform those operations, hand recognition module 56 may use steps like those described above with regard to block 120 of FIG. 2. And as indicated above, the hand geometry feature vector may describe various aspects of the hand.

Then, as shown at block 230, hand recognition module 56 may determine whether the new hand matches the original hand, and thus whether the current user is the authorized user. For example, hand recognition module 56 may use a pattern matching algorithm that computes the Euclidean distance between the feature descriptors for the original hand (as reflected in feature vector template 51) and the corresponding feature descriptors in the feature vector for the new hand. If the distance for any feature exceeds a predetermined threshold for that feature, hand recognition module 56 may conclude that the hands do not match. If the distance for all features is less than or equal to the corresponding thresholds, hand recognition module 56 may conclude that the hands do match.

The following table describes example values for twelve different feature descriptors, along with corresponding example thresholds of variance.

| Mean | Greatest Acceptable Variance |
|---|---|
| 0.25914 | 0.08512 |
| 0.39891 | 0.10991 |
| 1.33859 | 0.13181 |
| 0.26323 | 0.08314 |
| 0.19000 | 0.07288 |
| 0.17100 | 0.07573 |
| 0.51355 | 0.08894 |
| 0.10307 | 0.07471 |
| 1.07275 | 0.12893 |
| 0.18491 | 0.07346 |
| 0.10009 | 0.05905 |
| 0.17982 | 0.09114 |

If any feature from a sample hand varies more than the predetermined threshold for that feature (in either a plus or minus direction) then hand recognition module 56 will conclude that the sample hand does not match the original hand.

If the hands do not match, hand recognition module 56 may return a message indicating that authentication has failed, as shown at block 232, and then the process may then end. However, if the hands do match, user authentication module 54 may then perform gesture recognition, as described in greater detail below with regard to FIG. 3B.

As shown at block 310 of FIG. 3B, the gesture recognition process may start with gesture recognition module 58 showing a secret image to the current user. In one embodiment, gesture recognition module 58 uses a PAVP to display the secret image. In other embodiments, other techniques may be used to protect the secret image from being detected or intercepted by unauthorized software and/or hardware.

The secret image may include a question that is to be answered using a hand gesture. In addition or alternatively, the secret image may include instructions to perform a particular hand gesture. For example, the image may include a question and a numbered list of answers, and the instructions may ask the user to hold up a number of fingers to match the correct answer within the list of answers. Alternatively, the instructions may simply ask the user to make a particular gesture, described verbally and/or pictorially. For purposes of this disclosure, the term “gesture” includes moving gestures (e.g., a hand wave) and static gestures (e.g., a peace sign). A static gesture may also be referred to as a pose.

Gesture recognition module 58 may support many different kinds of gesture verification. For instance, gesture recognition module 58 may present a confidential question which requires the current user to use a hand gesture (e.g., holding up the right number of fingers) to select the answer that was previously provided by the authorized user. (E.g., “Were you born in <1> New Orleans, <2> Austin, <3> Santa Clara, or <4> Paris?”). Each time the question is presented, the order of the answers may be randomized. In addition or alternatively, gesture recognition module 58 may present instructions which require the current user to make a hand gesture that was previously specified by the authorized user. For instance, gesture recognition module 58 may instruct the current user to use his or her index finger to trace his or her password pattern in the air in front of the camera. Gesture recognition module 58 may also securely present a matrix of dots on the display, to provide a frame of reference for the pattern. Gesture recognition module 58 may subsequently determine whether the pattern traced by the current user matches the pattern previously provided by the authorized user, as described in greater detail below. The password pattern may also be referred to as a security pattern, and the data that gesture recognition module 58 saves to represent that pattern may be referred to as a security pattern definition. Gesture recognition module 58 may save security pattern definitions in secure storage 42.

In addition or alternatively, for a liveness test, user authentication module 54 may dynamically generate or select a security pattern, and user authentication module 54 may securely display that pattern to the current user, with instructions for the user to recreate the pattern with his or her finger in the air, in view of the camera.

As shown at block 312, gesture recognition module 58 may then collect and process multiple frames from camera 30. That processing may include hand segmentation and feature descriptor generation, as described above. The frames collected after providing gesture instruction to the user may be referred to as 2D video response data. As shown at block 314, gesture recognition module 58 may then determine, based on the collected frames, what hand gesture has been performed by the current user. Hand gesture detection may be based on pose detection and matching. For instance, gesture recognition module 58 may detect a sequence of hand poses from a sequence of frames, and gesture recognition module 58 may determine whether the detected poses match a predetermined required sequence of poses.

To detect or identify a hand pose, gesture recognition module 58 may determine whether particular hand parts in a frame match one or more pre-defined hand poses. Hand pose detection and matching may be based on the hand feature descriptors for the poses in the sequence of frames and on corresponding hand feature descriptors for the predetermined sequence of poses, as described by one or more pose templates 59 for a gesture template 57 in a gesture library 55. In addition, gesture recognition module 58 may use temporal recognition to interpolate poses that may not have been directly detected. For instance, gesture recognition module 58 may build a hidden Markov model to predict the dynamic movement of the hand, to make decisions on what gesture the person made.

As shown at block 320, gesture recognition module 58 may then determine whether the detected gesture is the correct gesture. If the detected gesture is not correct, gesture recognition module 58 may return authentication failure, as indicated by the line passing through page connector B to block 232 of FIG. 3A.

Gesture recognition module 58 may also use hand tracking and/or facial recognition to make sure that the hand making the gesture is the hand of the user who initiated the authentication process. For example, as shown at block 330, gesture recognition module 58 may determine whether the hand that passed biometric authentication left the view of camera 30 at any time before the gesture was completed. In addition or alternatively, gesture recognition module 58 may determine whether the face of the user who performed the gesture matches the face of the user who passed biometric authentication. In other words, gesture recognition module 58 may determine whether the face in view of camera 30 when the gesture was completed matches the face in view of camera 30 when biometric authentication was performed. If the hand left the view of camera 30 or if a different face is detected, gesture recognition module 58 may return authentication failure, as indicated by the line passing through page connector B to block 232 of FIG. 3A.

On the other hand, if the correct gesture was made, if hand tracking was successful, and if the face did not change, gesture recognition module 58 may then determine whether any additional verifications are needed, as shown at block 350. For example, gesture recognition module 58 may be configured to require the user (a) to trace the user's predefined password pattern in the air and also (b) to select a correct answer from a list by holding up a corresponding number of fingers. If any additional iterations are needed, the process may return to block 310. Once the user has successfully performed all necessary iterations, gesture recognition module 58 may return authentication success, as shown at block 352. And the authentication process may then end.

As has been described, a user authentication module may use a 2D camera to authenticate a user, based on hand recognition and gesture recognition. The user authentication module may be implemented as middleware that enables trusted authentication of a user. The user authentication module may use hand geometry and 2D hand gesture recognition, where hand geometry serves as user identity, and hand gesture recognition serves as password response.

Accordingly, the user may authenticate himself or herself without touching the data processing system. Furthermore, in some embodiments, the user need not even remember or enter a password. For instance, the data processing system may implement two-factor user authentication that only require the user to perform two tasks: (a) showing his or her hand to the camera and (b) performing a hand gesture specified by the data processing system. Moreover, a specific biometric sensor (e.g., a fingerprint reader) is not needed. Also, hand gestures in the air do not leave traces, like fingerprints do, so user authentication module may deter or defeat trace-based attacks.

A user authentication module may authenticate a user by using (a) biometric hand recognition followed by (b) challenge-response based hand-gesture recognition. For gesture recognition, the user authentication module may present the user with a randomized challenge, and the user authentication module may require the user to respond to that challenge with a predetermined hand gesture. Hand gesture recognition may be based on movements of the palm and the fingers, for instance as the user responds to a reverse Turing test by moving his or her hand as instructed by the user authentication module.

In addition, once a user's hand is identified as matched, the user authentication module may continuously to track the hand as it moves within view of the camera, to ensure that the gesture is made by the same hand that passed biometric authentication. The user authentication module may therefore ensure that the authorized user is present, and not just a photograph or computer rendering of the user.

The DPS may use PAVP or any other suitable technology to protect the challenge instructions from snooping. For example, to ensure that the image shown on the screen to the user is a shared secret between the user and the system, the DPS may use PAVP to protect the contents of the image, so it cannot be stolen by malware running on the DPS, since such malware would not be able to intercept and/or decrypt the encrypted frame buffer containing secret image. The DPS may also protect the feature vector template that is used as biometric information in the authentication stage.

The process for creating an original feature vector template for the authorized user may be referred to as an offline process. The process for subsequently authenticating the current user may be referred to as an online process. The offline process may include collecting the training data, computing the user's skin tone distribution, extracting hand feature descriptors, and securely saving a resulting feature vector template. The online process may use the saved offline data and the incoming video data of a 2D camera to perform background elimination, hand feature extraction, and hand biometric feature pattern matching to verify the current user's identify.

In addition, the user authentication module may also periodically update the original feature vector template for an authorized user to adapt to changes over time. The user authentication module 54 may also periodically update the skin tone distribution lookup table. Such updates may provide for adaptation with regard to changes in camera white balance, color correction, lighting, the background setting, and/or other factors affecting how a hand appears in a captured image.

In light of the principles and example embodiments described and illustrated herein, it will be recognized that the illustrated embodiments can be modified in arrangement and detail without departing from such principles. Also, the foregoing discussion has focused on particular embodiments, but other configurations are contemplated. Also, even though expressions such as “an embodiment,” “one embodiment,” “another embodiment,” or the like are used herein, these phrases are meant to generally reference embodiment possibilities, and are not intended to limit the invention to particular embodiment configurations. As used herein, these phrases may reference the same embodiment or different embodiments, and those embodiments are combinable into other embodiments.

Any suitable operating environment and programming language (or combination of operating environments and programming languages) may be used to implement components described herein. As indicated above, the present teachings may be used to advantage in many different kinds of data processing systems. Example data processing systems include, without limitation, distributed computing systems, supercomputers, high-performance computing systems, computing clusters, mainframe computers, mini-computers, client-server systems, personal computers (PCs), workstations, servers, portable computers, laptop computers, tablet computers, personal digital assistants (PDAs), telephones, handheld devices, entertainment devices such as audio devices, video devices, audio/video devices (e.g., televisions and set top boxes), vehicular processing systems, and other devices for processing or transmitting information. Accordingly, unless explicitly specified otherwise or required by the context, references to any particular type of data processing system (e.g., a mobile device) should be understood as encompassing other types of data processing systems, as well. Also, unless expressly specified otherwise, components that are described as being coupled to each other, in communication with each other, responsive to each other, or the like need not be in continuous communication with each other and need not be directly coupled to each other. Likewise, when one component is described as receiving data from or sending data to another component, that data may be sent or received through one or more intermediate components, unless expressly specified otherwise. In addition, some components of the data processing system may be implemented as adapter cards with interfaces (e.g., a connector) for communicating with a bus. Alternatively, devices or components may be implemented as embedded controllers, using components such as programmable or non-programmable logic devices or arrays, application-specific integrated circuits (ASICs), embedded computers, smart cards, and the like. For purposes of this disclosure, the term “bus” includes pathways that may be shared by more than two devices, as well as point-to-point pathways.

This disclosure may refer to instructions, functions, procedures, data structures, application programs, microcode, configuration settings, and other kinds of data. As described above, when the data is accessed by a machine or device, the machine or device may respond by performing tasks, defining abstract data types or low-level hardware contexts, and/or performing other operations. For instance, data storage, RAM, and/or flash memory may include various sets of instructions which, when executed, perform various operations. Such sets of instructions may be referred to in general as software. In addition, the term “program” may be used in general to cover a broad range of software constructs, including applications, routines, modules, drivers, subprograms, processes, and other types of software components. Also, applications and/or other data that are described above as residing on a particular device in one example embodiment may, in other embodiments, reside on one or more other devices. And computing operations that are described above as being performed on one particular device in one example embodiment may, in other embodiments, be executed by one or more other devices.

It should also be understood that the hardware and software components depicted herein represent functional elements that are reasonably self-contained so that each can be designed, constructed, or updated substantially independently of the others. In alternative embodiments, many of the components may be implemented as hardware, software, or combinations of hardware and software for providing the functionality described and illustrated herein. For example, alternative embodiments include machine accessible media encoding instructions or control logic for performing the operations of the invention. Such embodiments may also be referred to as program products. Such machine accessible media may include, without limitation, tangible storage media such as magnetic disks, optical disks, RAM, ROM, etc., as well as processors, controllers, and other components that include RAM, ROM, and/or other storage facilities. For purposes of this disclosure, the term “ROM” may be used in general to refer to non-volatile memory devices such as erasable programmable ROM (EPROM), electrically erasable programmable ROM (EEPROM), flash ROM, flash memory, etc. In some embodiments, some or all of the control logic for implementing the described operations may be implemented in hardware logic (e.g., as part of an integrated circuit chip, a programmable gate array (PGA), an ASIC, etc.). In at least one embodiment, the instructions for all components may be stored in one non-transitory machine accessible medium. In at least one other embodiment, two or more non-transitory machine accessible media may be used for storing the instructions for the components. For instance, instructions for one component may be stored in one medium, and instructions another component may be stored in another medium. Alternatively, a portion of the instructions for one component may be stored in one medium, and the rest of the instructions for that component (as well instructions for other components), may be stored in one or more other media. Instructions may also be used in a distributed environment, and may be stored locally and/or remotely for access by single or multi-processor machines.

Also, although one or more example processes have been described with regard to particular operations performed in a particular sequence, numerous modifications could be applied to those processes to derive numerous alternative embodiments of the present invention. For example, alternative embodiments may include processes that use fewer than all of the disclosed operations, process that use additional operations, and processes in which the individual operations disclosed herein are combined, subdivided, rearranged, or otherwise altered.

In view of the wide variety of useful permutations that may be readily derived from the example embodiments described herein, this detailed description is intended to be illustrative only, and should not be taken as limiting the scope of coverage.

The following examples pertain to further embodiments.

Example A1 is a data processing system with features for authenticating a user of the data processing system. The data processing system comprises a processor, a 2D camera responsive to the processor, at least one machine accessible medium responsive to the processor, and a user authentication module stored at least partially in the at least one machine accessible medium. The user authentication module comprises a hand recognition module and a gesture recognition module. When the user authentication module, is executed, the user authentication module uses the hand recognition module and the gesture recognition module to determine whether a current user of the data processing system is an authorized user. The hand recognition module is executable to perform operations comprising (a) obtaining 2D video data of a hand of the current user from the camera; and (b) automatically determining whether the hand of the current user matches a hand of the authorized user, based on the 2D video data of the hand of the current user. The gesture recognition module is executable to perform operations comprising (a) presenting a gesture challenge to the current user, wherein the gesture challenge asks the current user to perform a predetermined hand gesture; (b) obtaining 2D video response data for the current user from the camera; and (c) automatically determining whether the current user has performed the predetermined hand gesture, based on the 2D video response data.

Example A2 includes the features of Example A1, and the at least one machine accessible medium comprises a secure area of storage. The secure area of storage comprises a predetermined hand template for the authorized user. The operation of automatically determining whether the hand of the current user matches the hand of the authorized user comprises using the 2D video data of the hand of the current user and the predetermined hand template for the authorized user to determine whether the hand of the current user matches the hand of the authorized user.

Example A3 includes the features of Example A1, and the operation of presenting the gesture challenge to the current user comprises presenting the gesture challenge via a protected video path of the data processing system. Example A3 may also include the features of Example A2.

Example A4 includes the features of Example A1, and the at least one machine accessible medium comprises a gesture template for the predetermined hand gesture. Also, the operation of automatically determining whether the current user has performed the predetermined hand gesture comprises (a) detecting a hand gesture in the 2D video response data, and (b) determining whether the detected hand gesture matches the gesture template for the predetermined hand gesture. Example A4 may also include the features of any one or more of Example A2 through A3.

Example A5 includes the features of Example A1, and the gesture challenge presents a numbered list of items to the current user and instructs the current user to gesture a number to select an item from the list of items. Example A5 may also include the features of any one or more of Example A2 through A4.

Example A6 includes the features of Example A5, and the gesture recognition module is executable to perform operations comprising (a) including at least one correct answer and at least one incorrect answer in the list of items, and (b) using a randomized order to present the list of items. Also, the operation of automatically determining whether the current user has performed the predetermined hand gesture comprises automatically determining whether the current user has gestured the number for the correct answer. Example A6 may also include the features of any one or more of Example A2 through A4.

Example A7 includes the features of Example A1, and the at least one machine accessible medium comprises a secure area of storage which comprises a predetermined security pattern definition for the authorized user. The gesture challenge asks the current user to trace a security pattern in midair. The operation of automatically determining whether the current user has performed the predetermined hand gesture comprises automatically determining whether the 2D video response data for the current user matches the predetermined security pattern definition for the authorized user. Example A7 may also include the features of any one or more of Example A2 through A6.

Example A8 includes the features of Example A1, and the camera has a field of vision. Also, the gesture recognition module is executable to perform operations comprising (a) tracking the hand of the current user to determine whether the hand has left the field of vision of the camera, and (b) automatically returning a negative authentication result in response to a determination that the hand has left the field of vision. Example A8 may also include the features of any one or more of Example A2 through A7.

Example A9 includes the features of Example A1, and the gesture recognition module is executable to perform operations comprising (a) performing face recognition on the current user to recognize a first face, in conjunction with automatically determining whether the hand of the current user matches the hand of the authorized user; (b) performing face recognition on the current user to recognize a second face, in conjunction with automatically determining whether the current user has performed the predetermined hand gesture; and (c) automatically returning a negative authentication result in response to a determination that the first face does not match the second face. Example A9 may also include the features of any one or more of Example A2 through A8.

Example B1 is a method for authenticating a user of a data processing system. The method comprises using an inherence factor and a knowledge factor to determine whether a current user of a data processing system is an authorized user. The operation of using the inherence factor comprises (a) obtaining 2D video data of a hand of the current user from a camera of the data processing system; and (b) automatically determining whether the hand of the current user matches a hand of the authorized user, based on the 2D video data of the hand of the current user. The operation of using the knowledge factor comprises (a) presenting a gesture challenge to the current user, wherein the gesture challenge asks the current user to perform a predetermined hand gesture; (b) obtaining 2D video response data for the current user from the camera of the data processing system; and (c) automatically determining whether the current user has performed the predetermined hand gesture, based on the 2D video response data.

Example B2 includes the features of Example B1, and the method further comprises obtaining a predetermined hand template for the authorized user from a secure area of storage for the data processing system. Also, the operation of automatically determining whether the hand of the current user matches the hand of the authorized user comprises using the predetermined hand template for the authorized user and the 2D video data of the hand of the current user to determine whether the hand of the current user matches the hand of the authorized user.

Example B3 includes the features of Example B1, and the operation of presenting the gesture challenge to the current user comprises presenting the gesture challenge via a protected video path of the data processing system. Example B3 may also include the features of Example B2.

Example B4 includes the features of Example B1, and the operation of automatically determining whether the current user has performed the predetermined hand gesture comprises (a) detecting a hand gesture in the 2D video response data, and (b) determining whether the detected hand gesture matches a gesture template for the predetermined hand gesture. Example B4 may also include the features of any one or more of Example B2 through B3.

Example B5 includes the features of Example B1, and the gesture challenge presents a numbered list of items to the current user and instructs the current user to gesture a number to select an item from the list of items. Example B5 may also include the features of any one or more of Example B2 through B4.

Example B6 includes the features of Example B5, and the method further comprises (a) including at least one correct answer and at least one incorrect answer in the list of items, and (b) using a randomized order to present the list of items. Also, the operation of automatically determining whether the current user has performed the predetermined hand gesture comprises automatically determining whether the current user has gestured the number for the correct answer. Example B6 may also include the features of any one or more of Example B2 through B4.

Example B7 includes the features of Example B1, and the gesture challenge asks the current user to trace a security pattern in midair. Also, the operation of automatically determining whether the current user has performed the predetermined hand gesture comprises (a) obtaining a predetermined security pattern definition for the authorized user from a secure area of storage for the data processing system, and (b) automatically determining whether the 2D video response data for the current user matches the predetermined security pattern definition for the authorized user. Example B7 may also include the features of any one or more of Example B2 through B6.

Example B8 includes the features of Example B1, and the camera has a field of vision. Also, the method further comprises (a) tracking the hand of the current user to determine whether the hand has left the field of vision of the camera, and (b) automatically returning a negative authentication result in response to a determination that the hand has left the field of vision.

Example B8 may also include the features of any one or more of Example B2 through B7. Example B9 includes the features of Example B1, and the method further comprises (a) performing face recognition on the current user to recognize a first face, in conjunction with automatically determining whether the hand of the current user matches the hand of the authorized user; (b) performing face recognition on the current user to recognize a second face, in conjunction with automatically determining whether the current user has performed the predetermined hand gesture; and (c) automatically returning a negative authentication result in response to a determination that the first face does not match the second face. Example B9 may also include the features of any one or more of Example B2 through B8.

Example C is at least one machine accessible medium comprising computer instructions for using a 2D camera to authenticate a user. The computer instructions, in response to being executed on a data processing system, enable the data processing system to perform a method according to any one or more of Examples B1 through B9.

Example D is a data processing system with features for authenticating users. The data processing system comprises a processing element, at least one machine accessible medium responsive to the processing element, and computer instructions stored at least partially in the at least one machine accessible medium. Also, in response to being executed, the computer instructions enable the data processing system to perform a method according to any one or more of Examples B1 through B9.

Example E is a data processing system with features for authenticating users. The data processing system comprises means for performing the method of any one or more of Examples B1 through B9.

Example F1 is an apparatus to facilitate authentication of a user of a data processing system. The apparatus comprises a machine accessible medium and data in the machine accessible medium which, when accessed by a data processing system, enables the data processing system to use an inherence factor and a knowledge factor to determine whether a current user of the data processing system is an authorized user. The operation of using the inherence factor comprises (a) obtaining 2D video data of a hand of the current user from a camera of the data processing system; and (b) automatically determining whether the hand of the current user matches a hand of the authorized user, based on the 2D video data of the hand of the current user. The operation of using the knowledge factor comprises (a) presenting a gesture challenge to the current user, wherein the gesture challenge asks the current user to perform a predetermined hand gesture; (b) obtaining 2D video response data for the current user from the camera of the data processing system; and (c) automatically determining whether the current user has performed the predetermined hand gesture, based on the 2D video response data.

Example F2 includes the features of Example F1, and the operation of using the inherence factor comprises obtaining a predetermined hand template for the authorized user from a secure area of storage for the data processing system. Also, the operation of automatically determining whether the hand of the current user matches the hand of the authorized user comprises using the predetermined hand template for the authorized user and the 2D video data of the hand of the current user to determine whether the hand of the current user matches the hand of the authorized user.

Example F3 includes the features of Example F1, and the operation of presenting the gesture challenge to the current user comprises presenting the gesture challenge via a protected video path of the data processing system. Example F3 may also include the features of Example F2.

Example F4 includes the features of Example F1, and the operation of automatically determining whether the current user has performed the predetermined hand gesture comprises (a) detecting a hand gesture in the 2D video response data, and (b) determining whether the detected hand gesture matches a gesture template for the predetermined hand gesture. Example F4 may also include the features of any one or more of Example F2 through F3.

Example F5 includes the features of Example F1, and the gesture challenge presents a numbered list of items to the current user and instructs the current user to gesture a number to select an item from the list of items. Example F5 may also include the features of any one or more of Example F2 through F4.

Example F6 includes the features of Example F5, and the operation of presenting the gesture challenge comprises (a) including at least one correct answer and at least one incorrect answer in the list of items, and (b) using a randomized order to present the list of items. Also, the operation of automatically determining whether the current user has performed the predetermined hand gesture comprises automatically determining whether the current user has gestured the number for the correct answer. Example F6 may also include the features of any one or more of Example F2 through F4.

Example F7 includes the features of Example F1, and the gesture challenge asks the current user to trace a security pattern in midair. Also, the operation of automatically determining whether the current user has performed the predetermined hand gesture comprises (a) obtaining a predetermined security pattern definition for the authorized user from a secure area of storage for the data processing system; and (b) automatically determining whether the 2D video response data for the current user matches the predetermined security pattern definition for the authorized user. Example F7 may also include the features of any one or more of Example F2 through F6.

Example F8 includes the features of Example F1, and the camera has a field of vision. Also, the operation of automatically determining whether the current user has performed the predetermined hand gesture comprises (a) tracking the hand of the current user to determine whether the hand has left the field of vision of the camera, and (b) automatically returning a negative authentication result in response to a determination that the hand has left the field of vision. Example F8 may also include the features of any one or more of Example F2 through F7.

Example F9 includes the features of Example F1, and the data in the machine accessible medium enables the data processing system to perform operations comprising (a) performing face recognition on the current user to recognize a first face, in conjunction with automatically determining whether the hand of the current user matches the hand of the authorized user; (b) performing face recognition on the current user to recognize a second face, in conjunction with automatically determining whether the current user has performed the predetermined hand gesture; and (c) automatically returning a negative authentication result in response to a determination that the first face does not match the second face. Example F9 may also include the features of any one or more of Example F2 through F8.

What is claimed is:

1. A data processing system with features for authenticating a user of the data processing system, the data processing system comprising:
a processor;
a two-dimensional (2D) camera responsive to the processor;
at least one machine accessible medium responsive to the processer; and
a user authentication module stored at least partially in the at least one machine accessible medium, wherein the user authentication module comprises a hand recognition module and a gesture recognition module; and
wherein the user authentication module, when executed, uses the hand recognition module and the gesture recognition module to determine whether a current user of the data processing system is an authorized user;
wherein the hand recognition module is executable to perform operations comprising:
obtaining 2D video data of a hand of the current user from the camera; and
automatically determining whether the hand of the current user matches a hand of the authorized user, based on the 2D video data of the hand of the current user; and
wherein the gesture recognition module is executable to perform operations comprising:
presenting a gesture challenge to the current user, wherein the gesture challenge asks the current user to perform a predetermined hand gesture;
obtaining 2D video response data for the current user from the camera; and
automatically determining whether the current user has performed the predetermined hand gesture, based on the 2D video response data.

2. A data processing system according to claim 1, wherein:
the at least one machine accessible medium comprises a secure area of storage;
the secure area of storage comprises a predetermined hand template for the authorized user; and
the operation of automatically determining whether the hand of the current user matches the hand of the authorized user comprises using the 2D video data of the hand of the current user and the predetermined hand template for the authorized user to determine whether the hand of the current user matches the hand of the authorized user

3. A data processing system according to claim 1, wherein the operation of presenting the gesture challenge to the current user comprises presenting the gesture challenge via a protected video path of the data processing system.

4. A data processing system according to claim 1, wherein:
the at least one machine accessible medium comprises a gesture template for the predetermined hand gesture; and
the operation of automatically determining whether the current user has performed the predetermined hand gesture comprises:
detecting a hand gesture in the 2D video response data; and
determining whether the detected hand gesture matches the gesture template for the predetermined hand gesture.

5. A data processing system according to claim 1, wherein:
the at least one machine accessible medium comprises a secure area of storage;
the secure area of storage comprises a predetermined security pattern definition for the authorized user;
the gesture challenge asks the current user to trace a security pattern in midair; and
the operation of automatically determining whether the current user has performed the predetermined hand gesture comprises automatically determining whether the 2D video response data for the current user matches the predetermined security pattern definition for the authorized user.

6. A data processing system according to claim 1, wherein the camera has a field of vision, and the gesture recognition module is executable to perform operations comprising:
tracking the hand of the current user to determine whether the hand has left the field of vision of the camera; and
automatically returning a negative authentication result in response to a determination that the hand has left the field of vision.

7. A data processing system according to claim 1, wherein gesture recognition module is executable to perform operations comprising:
performing face recognition on the current user to recognize a first face, in conjunction with automatically determining whether the hand of the current user matches the hand of the authorized user;
performing face recognition on the current user to recognize a second face, in conjunction with automatically determining whether the current user has performed the predetermined hand gesture; and
automatically returning a negative authentication result in response to a determination that the first face does not match the second face.

8. A method for authenticating a user of a data processing system, the method comprising:
using an inherence factor and a knowledge factor to determine whether a current user of a data processing system is an authorized user;
wherein the operation of using the inherence factor comprises:
obtaining two-dimensional (2D) video data of a hand of the current user from a camera of the data processing system; and
automatically determining whether the hand of the current user matches a hand of the authorized user, based on the 2D video data of the hand of the current user; and
wherein the operation of using the knowledge factor comprises:
presenting a gesture challenge to the current user, wherein the gesture challenge asks the current user to perform a predetermined hand gesture;
obtaining 2D video response data for the current user from the camera of the data processing system; and
automatically determining whether the current user has performed the predetermined hand gesture, based on the 2D video response data.

9. A method according to claim 8, further comprising:
obtaining a predetermined hand template for the authorized user from a secure area of storage for the data processing system; and
wherein the operation of automatically determining whether the hand of the current user matches the hand of the authorized user comprises using the predetermined hand template for the authorized user and the 2D video data of the hand of the current user to determine whether the hand of the current user matches the hand of the authorized user.

10. A method according to claim 8, wherein the operation of presenting the gesture challenge to the current user comprises presenting the gesture challenge via a protected video path of the data processing system.

11. A method according to claim 8, wherein the operation of automatically determining whether the current user has performed the predetermined hand gesture comprises:
detecting a hand gesture in the 2D video response data; and
determining whether the detected hand gesture matches a gesture template for the predetermined hand gesture.

12. A method according to claim 8, wherein the gesture challenge presents a numbered list of items to the current user and instructs the current user to gesture a number to select an item from the list of items.

13. A method according to claim 12, further comprising:
including at least one correct answer and at least one incorrect answer in the list of items; and
using a randomized order to present the list of items; and
wherein the operation of automatically determining whether the current user has performed the predetermined hand gesture comprises automatically determining whether the current user has gestured the number for the correct answer.

14. A method according to claim 8, wherein:
the gesture challenge asks the current user to trace a security pattern in midair; and
the operation of automatically determining whether the current user has performed the predetermined hand gesture comprises:
obtaining a predetermined security pattern definition for the authorized user from a secure area of storage for the data processing system; and
automatically determining whether the 2D video response data for the current user matches the predetermined security pattern definition for the authorized user.

15. A method according to claim 8, wherein the camera has a field of vision, and the method further comprises:
tracking the hand of the current user to determine whether the hand has left the field of vision of the camera; and
automatically returning a negative authentication result in response to a determination that the hand has left the field of vision.

16. A method according to claim 8, further comprising:
performing face recognition on the current user to recognize a first face, in conjunction with automatically determining whether the hand of the current user matches the hand of the authorized user;
performing face recognition on the current user to recognize a second face, in conjunction with automatically determining whether the current user has performed the predetermined hand gesture; and
automatically returning a negative authentication result in response to a determination that the first face does not match the second face.

17. An apparatus to facilitate authentication of a user of a data processing system, the apparatus comprising:
a machine accessible medium; and
data in the machine accessible medium which, when accessed by a data processing system, enables the data processing system to use an inherence factor and a knowledge factor to determine whether a current user of the data processing system is an authorized user;
wherein the operation of using the inherence factor comprises:
obtaining two-dimensional (2D) video data of a hand of the current user from a camera of the data processing system; and
automatically determining whether the hand of the current user matches a hand of the authorized user, based on the 2D video data of the hand of the current user; and
wherein the operation of using the knowledge factor comprises:
presenting a gesture challenge to the current user, wherein the gesture challenge asks the current user to perform a predetermined hand gesture;
obtaining 2D video response data for the current user from the camera of the data processing system; and
automatically determining whether the current user has performed the predetermined hand gesture, based on the 2D video response data.

18. An apparatus according to claim 17, wherein the operation of using the inherence factor comprises:
obtaining a predetermined hand template for the authorized user from a secure area of storage for the data processing system; and
wherein the operation of automatically determining whether the hand of the current user matches the hand of the authorized user comprises using the predetermined hand template for the authorized user and the 2D video data of the hand of the current user to determine whether the hand of the current user matches the hand of the authorized user.

19. An apparatus according to claim 17, wherein the operation of presenting the gesture challenge to the current user comprises presenting the gesture challenge via a protected video path of the data processing system.

20. An apparatus according to claim 17, wherein the operation of automatically determining whether the current user has performed the predetermined hand gesture comprises:
detecting a hand gesture in the 2D video response data; and
determining whether the detected hand gesture matches a gesture template for the predetermined hand gesture.

21. An apparatus according to claim 17, wherein the gesture challenge presents a numbered list of items to the current user and instructs the current user to gesture a number to select an item from the list of items.

22. An apparatus according to claim 21, wherein:
the operation of presenting the gesture challenge comprises:
including at least one correct answer and at least one incorrect answer in the list of items; and
using a randomized order to present the list of items; and
the operation of automatically determining whether the current user has performed the predetermined hand gesture comprises automatically determining whether the current user has gestured the number for the correct answer.

23. An apparatus according to claim 17, wherein:
the gesture challenge asks the current user to trace a security pattern in midair; and
the operation of automatically determining whether the current user has performed the predetermined hand gesture comprises:
obtaining a predetermined security pattern definition for the authorized user from a secure area of storage for the data processing system; and
automatically determining whether the 2D video response data for the current user matches the predetermined security pattern definition for the authorized user.

24. An apparatus according to claim 17, wherein the camera has a field of vision, and the operation of automatically determining whether the current user has performed the predetermined hand gesture comprises:
tracking the hand of the current user to determine whether the hand has left the field of vision of the camera; and
automatically returning a negative authentication result in response to a determination that the hand has left the field of vision.

25. An apparatus according to claim 17, wherein the data in the machine accessible medium enables the data processing system to perform operations comprising:
performing face recognition on the current user to recognize a first face, in conjunction with automatically determining whether the hand of the current user matches the hand of the authorized user;
performing face recognition on the current user to recognize a second face, in conjunction with automatically determining whether the current user has performed the predetermined hand gesture; and
automatically returning a negative authentication result in response to a determination that the first face does not match the second face.
